(19) United States
(12) Patent Application Publication
(10) Pub. No.: US 2025/0112547 A1
(43) Pub. Date: Apr. 3, 2025

(54) MULTI-SOURCE NON-ELECTROLYTIC CAPACITOR BI-DIRECTIONAL ONBOARD CHARGER

(71) Applicant: xEVtech Co. Ltd., Baria city, VT (US)

(72) Inventors: Ngoc Hai Tran, Ba Ria city (VN); Dinh Tuyen Nguyen, Ba Ria City (VN)

(21) Appl. No.: 18/375,539

(22) Filed: Oct. 1, 2023

(51) Int. Cl. H02M 3/00; H02M 1/00; H02M 3/158; H02M 3/335

(52) U.S. Cl. CPC H02M 3/01; H02M 1/0077; H02M 3/1586; H02M 3/33576

(57) ABSTRACT

The present invention relates to a multi-source bi-directional onboard charger. The bi-directional onboard charger comprises input relays, an AC/DC converter, a staged circuit, and a DC/DC converter. The charger can either charge a battery by a power supplier or supply power to external loads by discharging the battery. The input relays are configured to accommodate multiple power sources including single-phase AC, three-phase AC, and DC power sources. Using relays and means for controlling the AC/DC converter with the staged circuit, the staged circuit is configured to perform various functions including a power decoupling circuit to replace electrolytic capacitor. The magnet of the DC/DC converter is optionally configured to be a 4-winding coupled inductor.

### BACKGROUND OF THE INVENTION

An onboard charger (OBC) is a power electronics device in an electric vehicle (EV). The OBC converts electricity-grid AC power to DC power for the vehicle's battery pack.

A conventional OBC is made of AC to DC (AC/DC) converter and DC to DC (DC/DC) converter. The AC/DC converter makes the grid current to be in-phase with the voltage of the grid power while the DC/DC converter regulates battery current. Electrolytic capacitors are usually placed at the output of the AC/DC converter for power conditioning, or power decoupling.

The AC/DC conversion stage is called the power factor correction stage. Power factor is ratio of true power to apparent power. If the ratio is less than 1, circuit wiring must carry more current than necessary. Power factor correction is a series of methods using electronic devices to improve the power factor to near to 1. Power factor losses can be either by displacement or distortion of the signal. Capacitors and inductors are used to resolve displacement and bring the current wave in phase with the voltage phase.

The electrolytic capacitors are to absorb second-harmonic power of the single-phase AC power from the grid. The benefits of large capacitance of electrolytic capacitors come with several drawbacks as well. Among these drawbacks are large leakage currents, value tolerances, equivalent series resistance and a limited lifetime. The primary mechanism that causes degradation and failure of electrolytic capacitors is slow evaporation of the electrolyte over time. This is made worse at higher temperatures. This results in lower capacitance and higher effective series resistance. Electrolytic capacitors have a limited lifetime, around 10,000 hours at high temperatures.

Integrating an auxiliary power decoupling circuit into the power converter is a well-known method to eliminate the electrolytic capacitor. The power decoupling circuit makes the instantaneous power between ac-grid and dc battery sides balanced. Hence, the capacitance requirement for the de-link between an input source to an output load is significantly reduced so that the electrolytic capacitors can be replaced by film or ceramic capacitors.

The DC/DC converters are devices that temporarily store electrical energy for the purpose of converting DC from one voltage level to another voltage level. The input DC power coming from power factor correction is either stepped up/down in the transformer in the middle of the DC/DC converter circuit. DC/DC converters, called LLC resonant converters, are widely used because they allow for higher switching frequencies and reducing switching losses. LLC resonant converters are ideal for power-demanding operations such as charging electric vehicles. An LLC converter is made up of 4 blocks: the power switches, resonant tank, transformer, and MOSFET power switches. First, the MOSFET power switches convert the input DC voltage into a high frequency square wave. This square wave then enters the resonant tank, which eliminates the square wave's harmonics and outputs a sine wave of the fundamental frequency. The sine wave is transferred to the secondary of the converter through a high-frequency transformer, which scales the voltage up or down. Lastly, the MOSFET power switches convert the sine wave into a stable DC output.

There are three different types of power supply that can be an input power to charge the EV's battery pack: single-phase AC power supply, three-phase AC power supply, and DC power supply. It is desirable to have an EV OBC to use any of these different types of charging. The present invention addresses multi-source charging solution and means to solve the electrolytic capacitor problem.

Bi-directional charging is the ability for electrical current to flow in both directions: from the grid to the vehicle (to charge the battery pack), and also from the battery of the vehicle to the grid, to another vehicle, or to household appliances. When an electric vehicle is charged, AC from the grid is converted to DC using the car's built-in converter. To send electricity out of the battery pack and back into the grid or into another electronic device, electricity must first convert back to AC. Bi-directional OBC is the OBC that has capability to have electrical current flow in both directions.

### SUMMARY OF THE INVENTION

The present invention is to reduce the capacitance requirement of decoupling capacitors between AC/DC converters and DC/DC converters. A power decoupling circuit replaces an electrolytic decoupling capacitor for single-phase AC input. The power decoupling circuit stores transient currents in a small capacity capacitor. A film capacitor is sufficient for that purpose.

The present invention also accommodates diverse power sources, single-phase AC, three-phase AC, and DC input. To accommodate different power sources, the circuit is transformed into a different configuration by switching on and off relay components. For single-phase AC input power, the power decoupling circuit processes the second-harmonic power of the single-phase AC power and stores it into a decoupling capacitor. The LLC converter controls the charging current and provides galvanic isolation between the battery and the input power. For three-phase AC input power, the power decoupling circuit functions as an interleaved buck converter controlling the charging current, and the LLC converter functions as a DC transformer providing galvanic isolation between the battery and the input power.

For DC input, there are two different configurations, one for “with galvanic isolation,” the other for “without galvanic isolation.” For “with galvanic isolation,” the AC/DC converter functions as an interleaved boost converter, the power decoupling circuit functions as an interleaved buck converter, and the LLC converter functions as a DC transformer.

The “without galvanic isolation” configuration applies when the voltage of DC input source is lower than battery voltage. There are two configurations for the “without galvanic isolation,” one for bypassing the transformer of the DC/DC converter, the other for converting the transformer of the DC/DC converter to a coupled inductor with 4-windings. For the bypassing configuration, both the AC/DC converter and the power decoupling circuit function as interleaved boost converters, and the DC/DC converter is bypassed. For the coupled inductor configuration, the DC/DC converter becomes a boost converter that increases the charging power to the battery.

The present invention utilizes the idea that a transformer can be used as a coupled inductor. By activating the tap of primary magnet and the tap of secondary magnet of a tap transformer, it turns the transformer into a coupled inductor with 4-windings. This coupled inductor with 4-windings increases the DC charging power of the DC/DC converter. In this context the transformer of the DC/DC converter becomes a multi-functional magnet, a magnet functioning as a transformer or a magnet functioning as a coupled inductor with 4-windings. The term “multi-functional magnet” is used to show that a transformer can be used either as a typical transformer or as a coupled inductor with 4-windings.

The present invention has the capability to function either as a charger or as a discharger. It functions as an AC/DC converter in charging the battery pack. It functions as a DC/AC inverter in discharging the battery to supply power to the load. The configuration remains unchanged; only the current direction is reversed. In charging mode, power can flow from the AC grid to the battery, while in discharging mode, power can be discharged from the battery to the grid or load.

### BRIEF DESCRIPTION OF DRAWINGS

FIG. 1 shows a general circuit structure of the present invention.

FIG. 2 shows a circuit and block diagram for single-phase AC source input.

FIG. 2-1 shows an embodiment of a power decoupling circuit for single-phase AC source input.

FIG. 3 shows a circuit and block diagram for three-phase AC source input.

FIG. 4 shows a circuit and block diagram for DC source input, and with galvanic isolation.

FIG. 5 shows a circuit and block diagram for DC source input, and without galvanic isolation.

FIG. 6 shows a circuit and block diagram for DC source, without galvanic isolation, with configuration of 4-phase interleaved boost converter increasing the charging power.

FIG. 7 shows a circuit configuration to be used for multi-functional magnet.

FIG. 8 illustrates the magnet of the LLC converter utilized in multi-functional way, one used as in transformer mode and the other used as in coupled inductor mode.

FIG. 9-1, FIG. 9-2, and FIG. 9-3 show alternative embodiment of the present invention shown in FIG. 1.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiment set forth herein. Rather, these embodiments are provided so that this disclosure will be thorough and complete, and will fully convey the scope of the invention to those skilled in the art.

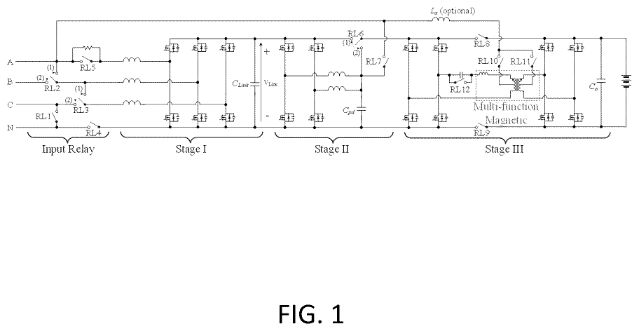

FIG. 1 shows a general circuit structure of the present invention. The RL's of the figure are relay switches through which the circuit is configured to accept different types of power sources including single-phase AC, three-phase AC, and DC sources. The circuit is divided into three stages: the stage I functioning as an AC/DC converter for AC input or a boost converter for DC input; the stage II functioning as a power decoupling circuit or interleaved boost/buck converter; and the stage III functioning as a DC/DC converter. A multi-functional magnet of the stage III is configured to be a transformer or an interleaved boost converter with coupled inductor.

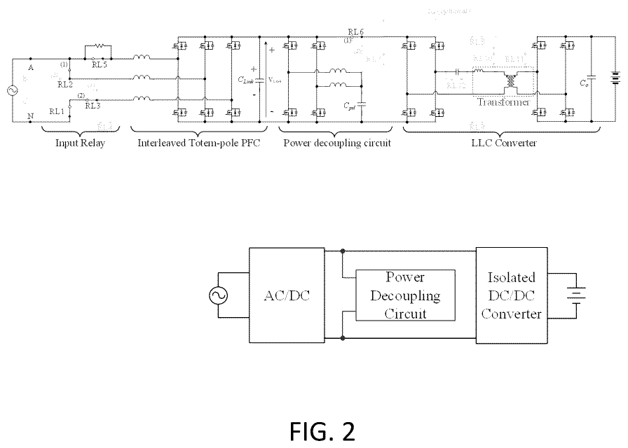

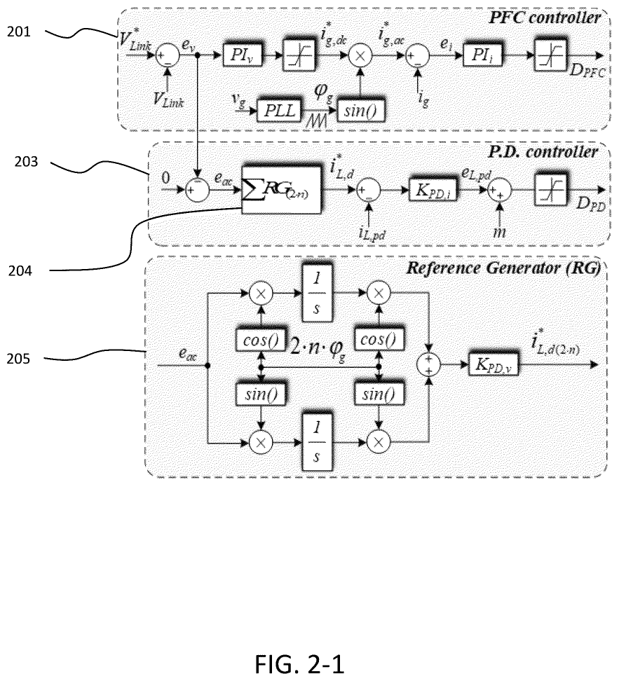

FIG. 2 shows a circuit and a corresponding block diagram for single-phase AC source. In FIG. 2, the stage I functions as interleaved totem-pole power factor correction circuit, controlling DC Link voltage V_{Link}. In the stage II, the RL 6 switch is positioned to position (1), and the RL7 is open. The stage II functions as a power decoupling circuit processing and storing second-order power of the single-phase AC source into C_{pd}, therefore, reducing the needed capacitance value for the capacitor C_{Link}, enabling the use of a film capacitor. The stage III operates as an LLC Converter. The RL8,9,10,11,12 are open. The multi-functional magnet of the LLC converter functions as a transformer providing galvanic isolation between the battery and the input source.

FIG. 2-1 shows a controller for the power factor correction (PFC) with power decoupling (PD) circuit. The PFC controller 201 is connected to the PD controller 203. The functionality of the reference generator (RG) 204 is shown in the RG block 205. This controller ensures dc-link voltage is controlled at the desired value while storing all the second harmonic in the power decoupling capacitor Cpd. As shown in FIG. 2-1, the controller consists of three blocks as shown below.
1) The PFC controller 201 uses a dual-loop control which consists of two loops: the outer voltage control loop (PI_{V}); and the inner current control loop (PI_{L}). The voltage loop ensures the output voltage remains at the desired setpoint, while the current loop regulates the input current to be in-phase with the input voltage. The phase locked loop (PLL) synchronizes the current control with the grid's phase, ensuring power factor correction and optimal power transfer.
2) The PD controller 203 controls the second-harmonic power from the single-phase AC source, storing it into the decoupling capacitor. This controller uses the difference between actual dc-link voltage and desired value to generate the reference current, using the Reference Generator block, for the power decoupling circuit. The proportional controller K_{PD,i} is then used to control that the actual current of the power decoupling circuit follows its reference current.
3) The reference generator (RG) 205 is for establishing the current reference required to absorb and transfer energy between the PD capacitor and the DC-link voltage. To match the desired voltage reference and reduce the computational effort, unbalanced ab/dq transformation is employed to convert even-harmonic ripple voltage into DC-ripple voltage in the rotating frame, eliminating the need for a beta frame. Consequently, integral controller can be used to generate the necessary PD current magnitude in the DC frame at the even frequency, which is then converted back to the stationary frame to facilitate the PD algorithm. A proportional controller K_{PD,v} is then used to achieve the desired bandwidth. It is worth noting that the bandwidth of the half-bridge split capacitor power decoupling (HSC-PD) voltage must be faster than that of the PFC voltage to ensure timely tracking of the power in the PFC stage. To maintain a stable closed-loop control system, feedback on the current in the PD inductor and precise tracking of the current reference for HSC-PD voltage RG is required. These components collectively contribute to optimizing the performance of the HSC-PD circuit ensuring the DC-link voltage remains as stable as possible.

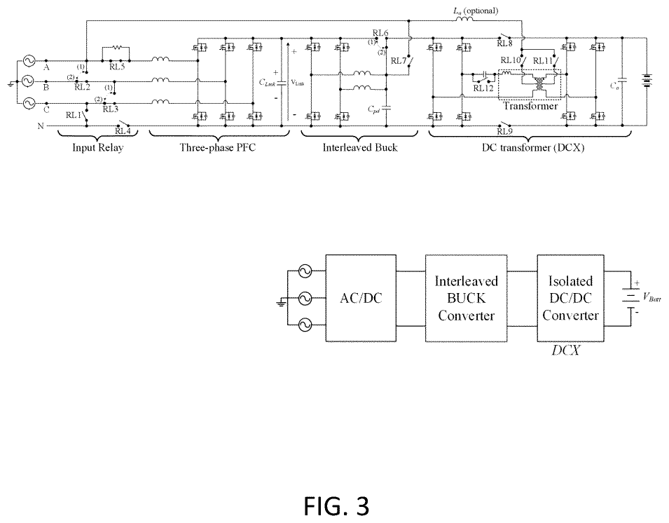

FIG. 3 shows a circuit and a corresponding block diagram for three-phase AC source. In FIG. 3, the stage I functions as three-phase power factor correction circuit, controlling DC Link voltage V_{Link}. In the stage II, the RL 6 switch is positioned at position (2), and the RL7 is open. The stage II functions as an interleaved buck converter regulating the battery current during charging process. The stage III operates as a DC transformer (DCX). The RL8,9,10,11,12 are open. The multi-functional magnet functions as a transformer providing galvanic isolation between the battery and input source.

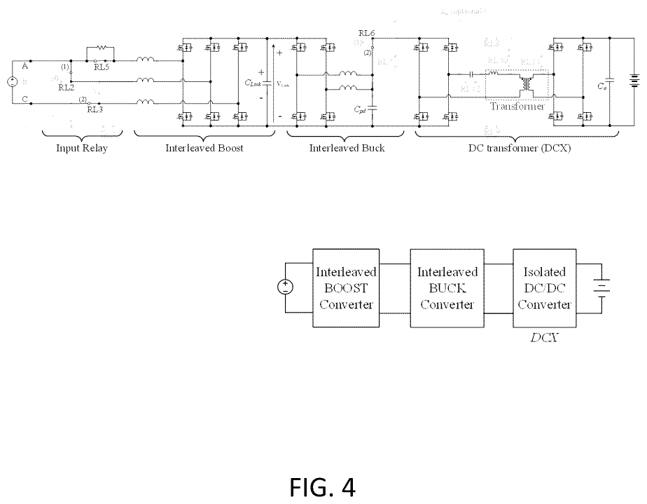

FIG. 4 shows a circuit and block diagram for DC source, and with galvanic isolation. In FIG. 4, the stage I functions as interleaved boost converter, controlling DC Link voltage V_{Link}. In the stage II, the RL 6 switch is positioned at position (1), the RL7 is open, the stage II functions as an interleaved buck converter regulating the battery current during charging process. The stage III operates as a DC transformer (DCX). The RL8,9,10,11,12 are open. The multi-functional magnet functions as a transformer providing galvanic isolation between the battery and input source.

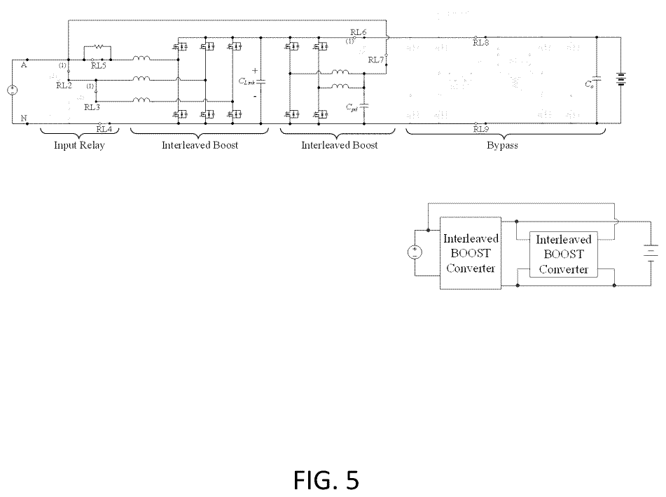

FIG. 5 shows a circuit and block diagram for DC source, and without galvanic isolation. This is applied in case of the voltage of DC input source is lower than battery voltage, and the galvanic isolation is not required. The stage I functions as an interleaved boost converter, controlling DC Link voltage V_{Link}. In the stage II, the RL 6 switch is positioned at position (2), and the RL7 is closed. The stage II functions as an interleaved boost converter, connected in parallel to stage I, increasing the charging power. In the stage III, the RL10,11,12 are open, and the RL8,9 are closed, resulting in bypassing the stage III.

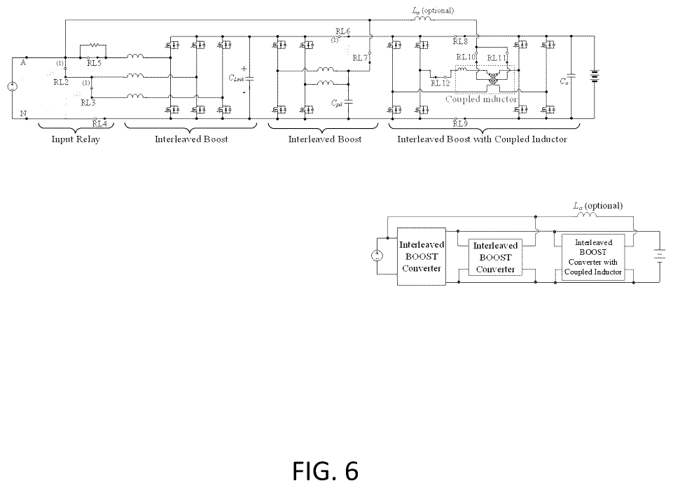

FIG. 6 shows a circuit and block diagram for DC source, without galvanic isolation, with configuration of 4-phase interleaved boost converter increasing the charging power. This is applied in case of the voltage of DC input source is lower than battery voltage, and the galvanic isolation is not required. The stage I functions as interleaved boost converter, controlling DC Link voltage V_{Link}. In the stage II, the RL 6 switch is positioned at position (2), and the RL7 is closed. The stage II functions as an interleaved boost converter, connected in parallel to stage I, increasing the charging power. In the stage III, the RL8,9,10,11,12 are closed. The stage III functions as 4-phase interleaved boost converter utilizing the multi-functional magnet as a 4-phase coupled inductor. The stage III is connected in parallel with stage I and stage II, further increasing the charging power.

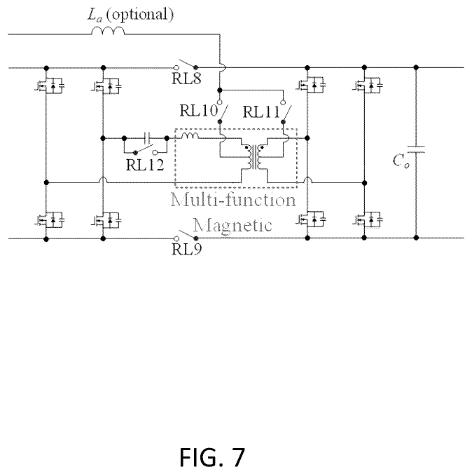

FIG. 7 shows a circuit diagram illustrating multi-functional magnet. The multi-functional magnet becomes a coupled inductor with 4-windings when the tap of the primary magnet and the tap of the secondary magnet is activated by closing RL10 and RL11. RL8,9,12 should be closed as well to have the coupled inductor with 4-windings become an interleaved boost converter. La is an optional inductor to be used for the 4-winding coupled inductor to reduce the current ripple. The multi-functional magnet functions as a transformer when all the relays are open.

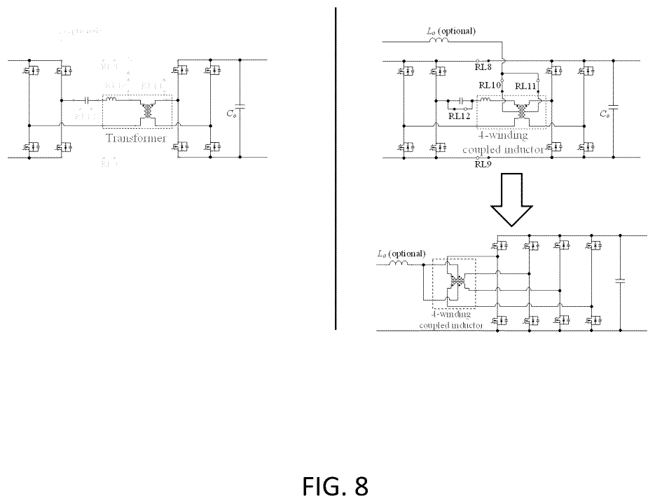

FIG. 8 illustrates the magnet of the LLC converter utilized in a multi-functional way. The magnet functions as a transformer when all the relays RL8,9,10,11,12 are open. The magnet functions as a 4-winding coupled inductor when all the relays are closed.

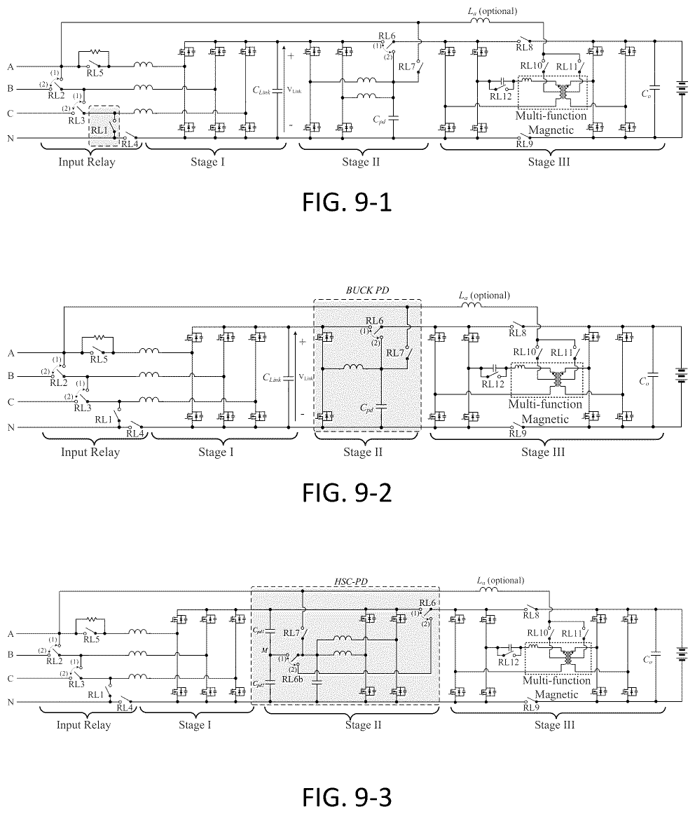

FIG. 9-1, FIG. 9-2, FIG. 9-3 show alternative embodiment of the present invention shown in FIG. 1. FIG. 9-1 shows the relay RL1 is at a position which is different from the position of the relay RL1 of FIG. 1. FIG. 9-2 shows that the interleaved buck of stage II of FIG. 1 is changed to a buck converter for lower power rating OBC. FIG. 9-3 shows that the buck type power decoupling is changed to HSC-PD with additional relay RL6b. The HSC-PD can utilize de-link capacitor as a power decoupling capacitor in single-phase AC input source.

One skilled in the art, after being exposed to the teachings provided in the preceding descriptions and associated drawings, will likely conceive various modifications and alternative embodiments of the invention. Hence, it is important to note that the invention is not limited to the disclosed specific embodiments, and that modifications and alternative embodiments are intended to be encompassed within the scope of the appended claims.

Thus, the scope of the present disclosure is to be determined by the broadest permissible interpretation to the maximum extent allowed by law, of the following claims, and shall not be restricted or limited by the foregoing description.

1. A multi-source non-electrolytic capacitor bi-directional onboard charger, comprising:
input relays connected to input power source;
an AC to DC converter connected to the input relays and having its output terminal;
a staged circuit connected to the output terminal of the AC to DC converter and its output terminal connected to input terminal of an LLC resonant DC to DC converter;
means for switching the functionality of the staged circuit with relays in the staged circuit;
the LLC resonant DC to DC converter connected between the staged circuit and a battery;
and means for charging or discharging the battery.

2. The input power source of claim 1 includes single-phase AC, three-phase AC, or DC input.

3. The AC to DC converter of claim 1, wherein the converter is configured to be an interleaved totem-pole power factor correction circuit for single-phase AC source input.

4. The AC to DC converter of claim 1, wherein the converter is configured to be a three-phase power factor correction circuit for three-phase AC source input.

5. The AC to DC converter of claim 1, wherein the converter is configured to be an interleaved boost converter for DC source input.

6. The staged circuit of claim 1, wherein the staged circuit is configured to be a power decoupling circuit with non-electrolytic capacitor for single-phase AC source input.

7. The staged circuit of claim 1, wherein the staged circuit is configured to be an interleaved buck converter for three-phase AC source input.

8. The staged circuit of claim 1, wherein the staged circuit is configured to be an interleaved buck converter for DC source input with galvanic isolation.

9. The staged circuit of claim 1, wherein the staged circuit is configured to be an interleaved boost converter for DC source input without galvanic isolation.

10. The LLC resonant DC to DC converter of claim 1 comprises resonant tank, multi-functional magnet, MOSFET power switches, and relays.

11. The LLC resonant DC to DC converter of claim 1 with means for bypassing the multi-functional magnet of claim 10.

12. Means for transforming the multi-functional magnet of claim 10 to a 4-winding coupled inductor.

13. Means for controlling the AC to DC converter of claim 1 with the staged circuit of claim 1.
